(19) United States
(12) Patent Application Publication
(10) Pub. No.: US 2022/0261450 A1
(43) Pub. Date: Aug. 18, 2022

(54) SYSTEMS AND METHODS FOR PRODUCING SEARCH RESULTS BASED ON USER PREFERENCES

(71) Applicant: NEGENTROPICS MESTERSEGES INTELLIGENCIA KUTATO ES F, Budapest (HU)

(72) Inventor: Zoltan Uzonyi, Budapest (HU)

(21) Appl. No.: 17/687,454

(22) Filed: Mar. 4, 2022

Related U.S. Application Data
(63) Continuation of application No. 16/166,923, filed on Oct. 22, 2018.

(51) Int. Cl. G06F 16/9535; G06F 16/2457; G06F 16/248

(52) U.S. Cl. CPC G06F 16/9535; G06F 16/248; G06F 16/24578

(57) ABSTRACT

Methods for producing personalized search results. The methods may include identifying a first list of search results associated with a search query from a user; identifying a search profile of the user; generating a set of characteristic features for each search result of the first list of search results, wherein each set of characteristic features describes the content of a search result in a binary form; identifying, in the first list of search results, one or more search results having characteristic features matching the characteristic features of the search profile; based on the matching, generating a second list of search results organized by the relevance of the search results with respect to the search profile; and providing the second list of search results to the user.

### TECHNICAL FIELD

The present disclosure relates generally to the field of search engines in computer network systems and, in particular, to systems and methods of personalizing search results using personal preferences of the users.

### BACKGROUND

Search engines are powerful tools for locating and retrieving documents from the Internet (or from an intranet). Recently, search engines have been widely using profiles of their users to provide the most relevant search results to each user. However, these user profiles often include user-specific information relating to either permanent characteristics of the user, such as personal data, interests, etc., or information relating to the user's past activity on the internet, such as browser history, search queries, behavior of the user, etc.

Often, user profiles are generated without explicit input from the user with regard to their personal preferences and interests, which are automatically collected by the search engine system. For example, a user profile may include a set of user-preferred search results that is determined at least in part from the user's search history and from one or more supplemental search results that are similar to at least one of the user-preferred search results. Among the list of search results, the search engine identifies one or more search results that are associated with the supplemental search results. Finally, the search engine reorders the list of search results based on the user profile.

However, current search engine systems allow a user to have a very limited influence on the content of his profile through his search activity, which is used to automatically generate the profile. Often, the user does not have direct control over the content of his profile. Consequently, searches using the automatically generated user profiles may result in a higher number of irrelevant search results.

Thus, there exists a need for a system and a method that can personalize search results so as to provide documents in the search results in an order based on which documents are most likely to be of interest to the user who submitted the search query.

Further, there exists a need for a system or method to operate with an explicit input from a user with regard to the user's personal preferences and interests. Additionally, the system may be configured to update the search profile of the user through user interactions.

### BRIEF SUMMARY

In one embodiment, a computer-implemented method of producing personalized search results may include: identifying a first list of search results associated with a search query from a user; identifying a search profile of the user; generating a set of characteristic features for each search result of the first list of search results, wherein each set of characteristic features describes the content of a search result in a binary form; identifying, in the first list of search results, one or more search results having characteristic features matching the characteristic features of the search profile; based on the matching, generating a second list of search results organized by the relevance of the search results with respect to the search profile; and providing the second list of search results to the user. The search profile may include: an identification of a topic defined by the user; an identification of a set of documents associated with the user, wherein the set of documents contains content matching the topic defined by the user; and an identification of a set of characteristic features describing the topic in a binary form, wherein the set of characteristic features is derived from at least the content of the set of documents.

In one aspect, generating the second list of search results may further comprise reordering the first list of the search results based on one or more quality factors determined for each search result in the matching process according to a predetermined scheme.

In one aspect, generating the second list of search results may further comprise filtering the second list of search results by one or more quality factors determined for each search result in the matching process. Filtering the second list search results may further comprise selecting one or more search results having a quality factor meeting a predefined filtering criteria. The quality factor of a search result may comprise a relevance score of the search result with respect to the search profile. The filtering criteria may comprise a threshold value for the relevance score.

In another embodiment, a computer-implemented method of producing personalized search results, performed on a server system having one or more processors and memory storing one or more programs for execution by the one or more processors to perform the method, may comprise: identifying a list of search results associated with a search query from a user; identifying a plurality of shared search profiles of one or more other users; generating a set of characteristic features for each search result of the returned list, said set of characteristic features describing the content of the search result in a binary form; for at least one search result, identifying one or more shared search profiles of the one or more other users, the topics of which match the content of the search results based on the characteristic features of the search results and the characteristic features of said plurality of shared search profiles; based on the matching process, generating a list of search results with recommended shared search profiles, wherein at least one shared search profile of at least one other user is associated with at least one of the search results; providing the list of search results with recommended shared search profiles to the user; and upon selecting a recommended shared search profile of another user, using the selected recommended shared search profile in a new search to obtain a personalized list of search results. The shared search profile may include an identification of a set of documents collected by the user, wherein the documents belonging to a search profile have a content matching a specific topic defined by the user for the respective search profile, and wherein each search profile further includes an identification of a set of characteristic features describing a search topic in a binary form, said characteristic features of the search profile being derived from at least the content of the documents assigned to the respective search profile.

In an aspect, identifying one or more shared search profiles for the search results may comprise determining a set of quality factors for each shared search profile according to a predetermined scheme, a quality factor being indicative of the degree of matching between the topic of the shared search profile and the content of a search result. The step of generating the list of search results may comprise selecting a shared search profile for recommendation to a search result if the respective quality factor meets predefined filtering criteria. A quality factor of a search profile may be defined as a score of relevance of the shared search profile with respect to a search result, and the filtering criteria may include a threshold value for the relevance of the shared search profile, and a shared search profile may be recommended to a search result if its score of relevance exceeds said threshold value.

In another embodiment, a computer-implemented method of producing personalized search results, performed on a server system having one or more processors and memory storing one or more programs for execution by the one or more processors to perform the method, may include: identifying a search query from a user; identifying a plurality of shared search profiles of one or more other users, wherein each search profile include an identification of a set of documents collected by the user, wherein the documents belonging to a search profile have a content matching a specific topic defined by the user for the respective search profile, and wherein each search profile further includes an identification of a set of characteristic features describing a search topic in a binary form, said characteristic features of the search profile being derived from at least the content of the documents assigned to the respective search profile; generating a set of characteristic features for the search query, said set of characteristic features describing the content of the search query in a binary form, for the search query, identifying one or more shared search profiles of the one or more other users, the topics of which match the content of the search query based on the characteristic features of the search query and the characteristic features of said plurality of shared search profiles; based on the matching process, generating a list of at least one recommended shared search profile; providing the list of the at least one recommended shared search profile to the user; and upon selecting a recommended shared search profile of another user, using the selected recommended shared search profile in a new search to obtain a personalized list of search results.

In an aspect, the step of identifying one or more shared search profiles for the search query may comprise determining a set of quality factors for the search query according to a predetermined scheme, a quality factor being indicative of the degree of matching between the topic of the shared search profile and the content of a search query. The step of generating the list of at least one recommended shared search profile may comprise selecting a shared search profile for recommendation to the search query if the respective quality factor meets predefined filtering criteria. The quality factor of a search profile may be defined as a score of relevance of the shared search profile with respect to the search query, and the filtering criteria may include a threshold value for the relevance of the shared search profile, and a shared search profile may be recommended to the search query if its score of relevance exceeds said threshold value.

It is to be understood that both the foregoing general description and the following detailed description are exemplary and explanatory only and are not restrictive of the disclosed embodiments, as claimed.

### BRIEF DESCRIPTION OF THE DRAWINGS

The accompanying drawings, which are incorporated in and constitute a part of this specification, illustrate exemplary disclosed embodiments and, together with the description, serve to explain the disclosed embodiments. In the drawings:

FIG. 1 is a block diagram of an exemplary distributed system that includes a plurality of clients requesting information from an information server, consistent with disclosed embodiments.

FIG. 2 depicts an exemplary data structure of a search profile, consistent with disclosed embodiments.

FIG. 3 is a flowchart of a process for generating a search profile, consistent with disclosed embodiments.

FIG. 4 is a flowchart of a process for updating a search profile, consistent with disclosed embodiments.

FIG. 5 is a flowchart of a process for personalizing search results, consistent with disclosed embodiments.

FIG. 6 is a flowchart of a process of sharing a search profile, consistent with disclosed embodiments.

FIG. 7 is a flowchart of a process for personalizing search results using shared search profiles of other users, consistent with disclosed embodiments.

FIG. 8 is a flowchart of a process of recommending new documents for a search profile, consistent with disclosed embodiments.

FIG. 9 is a flowchart of another process for personalizing search results using shared search profiles of other users, consistent with disclosed embodiments.

### DETAILED DESCRIPTION

Reference will now be made in detail to embodiments, examples of which are illustrated in the accompanying drawings. Wherever convenient, the same reference numbers will be used throughout the drawings to refer to the same or like parts. In the following detailed description, numerous specific details are set forth in order to provide a thorough understanding of the subject matter presented herein. However, it will be apparent to one skilled in the art that the subject matter may be practiced without these specific details. In other instances, well-known methods, procedures, components, and circuits have not been described in detail so as not to unnecessarily obscure aspects of the embodiments.

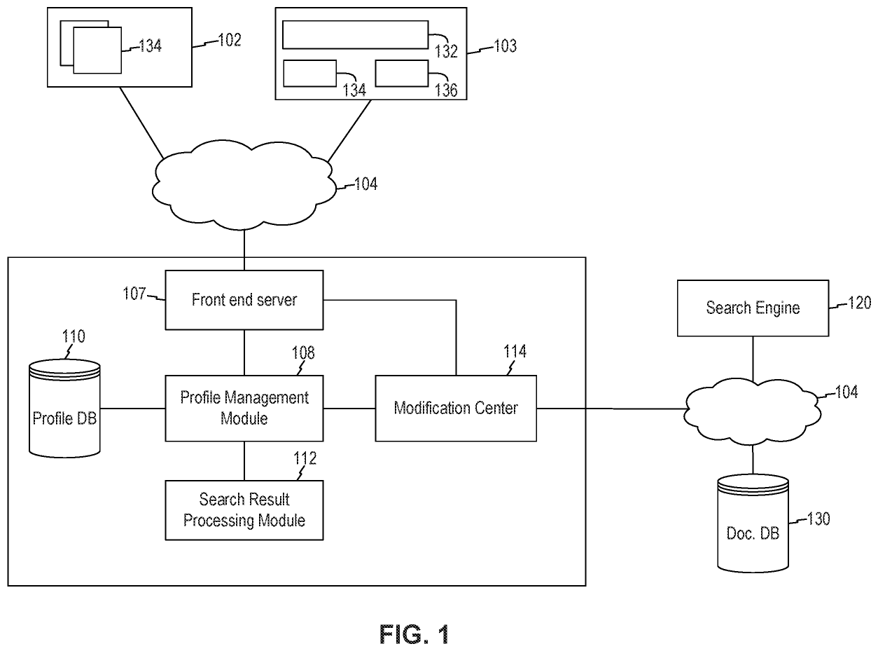

FIG. 1 is a block diagram of an exemplary environment 100 for implementing a system for producing personalized search results, consistent with disclosed embodiments. In some embodiments, one or more websites 102 and clients 103 can be connected to a communication network 104. The communication network 104 may be connected to a search management system 106. The search management system 106 may include a front-end server 107, a profile management module 108, a profile database 110, a search result processing module 112 and a notification center 114. The search management system 106 may be connected to a search engine 120, which in turn, may be connected to a document database 130.

In some embodiments, the search management system 106 contains a subset or superset of the elements illustrated in FIG. 1. Although FIG. 1 shows the search management system 106 as a number of discrete items, the figure is intended more as a functional description of the various features which may be present in the search management system 106 rather than a structural schematic of the various embodiments. In some embodiments, components shown separately may be functionally combined. Alternatively, the functions of certain components may be further separated and distributed, as would be recognized by one skilled in the art. For example, the databases 110, 130 shown separately in FIG. 1 may be implemented by one or more distinct databases spread over as many servers as needed to store and provide timely access to the data in the databases. The number of computers constituting the search management system 106 and the allocation of features among the computers may vary from one implementation to another and may depend in part on the amount of traffic that the search management system 106 handles during peak usage periods as well as during average usage periods.

Website 102 may be, for example, a collection of webpages 116 associated with a domain name on the Internet. Each webpage has a universal resource locator (URL) that uniquely identifies the location of the webpage on the Internet. For example, a visitor can access the webpage by entering its URL in a browser window. A website, or a set of relating webpages belonging to the same domain name, can be hosted by a web server exclusively owned by the owner of the domain name or by a web server of an Internet service provider that manages multiple websites associated with different domain names.

A client 103 may be any of a number of devices (e.g., a computer, an internet kiosk, a personal digital assistant, a cell phone, a gaming device, a desktop computer, a laptop computer, etc.) and may include a client application 132, a client assistant 134, and/or client memory 136. The client application 132 may be a software application that permits a user to interact with the client 103 and/or network resources to perform one or more tasks. For example, in some embodiments, the client application 132 is a browser (e.g., Firefox®, Chrome®, Internet Explorer®, etc.) or other type of application that permits a user to search for, browse, and/or use resources (e.g., web pages and web services) at the website 102 from the client 103. The client assistant 134 may be a software application that performs one or more tasks related to monitoring or assisting a user's activities with respect to the client application 132 and/or other applications. For instance, the client assistant 134 may assist a user at the client 103 with browsing for resources (e.g., files) hosted by the website 102; processes information (e.g., search results) received from the search management system 106; and/or monitors the user's activities on the search results. In some embodiments the client assistant 134 is part of the client application 132, available as a plug-in or extension to the client application 132 (provided, for example, from various online sources), while in other embodiments the client application is a stand-alone program separate from the client application 132. Client memory 136 may store information such as webpages, documents received from the search management system 106, system information, and/or information about a user.

The communication network 104 may be any wired or wireless local area network (LAN) and/or wide area network (WAN), such as an intranet, an extranet, or the Internet. In some embodiments, the communication network 104 may provide communication capability between the websites 102, the clients 103, and the search management system 106. In some embodiments, the communication network 104 uses the Hypertext Transport Protocol (HTTP) to transport information using the Transmission Control Protocol/Internet Protocol (TCP/IP). The HTTP permits client computers to access various websites available via the communication network 104. The various embodiments, however, are not limited to the use of any particular protocol.

To receive a set of personalized search results, a user, via client 103 (for example), submits a search request to the search management system 106. In some embodiments, the search request may include a search query comprising one or more query terms and/or one or more unique identifiers of the requesting user and the requesting client 103.

Within the search management system 106, the front-end server 107 may be configured to handle search requests from the client 103 via their respective connections with the communication network 104. As shown in FIG. 1, the front-end server 107 may be connected to the search engine 120, and the search engine 120 may be connected to the document database 130, respectively. The front-end server 107 also provides the client 103 with a user interface allowing the user to manage the search queries and the search profiles.

The document database 130 may store a plurality of indexed documents and may serve as a document source for the personalized search. The document database 130 may be a database storing documents retrieved from different websites 102. Alternately, or in addition, the document database 130 may store an index pointing to documents stored at various websites 102 or other locations. In some embodiments, the document database 130 may be a document store, for example, document database 130 may be a public document store, such as a public document store of a company, an institution, or an authority. In some embodiments, document database 130 may be a private (non-public) document store, such as an internal document store of a company, institution, authority or other entity. The search engine 120 and the document database 130 may be connected to the search management system 106 through a communication network 104 that may be the same as or different from the communication network 104 connecting the search management system 106 with the one or more websites 102 and the one or more clients 103.

The documents stored in the document database 130 may include any type of contents. For example, documents, as used herein, may include text documents, images, video files, audio files, hypertext documents or any combination thereof. The term “documents” may also be used to refer to search results, since the search engine may return a list of documents with specific information elements associated with the resulted documents. Each document stored in the document database 130 may be associated with a unique document identifier, such as a sequence ID, a document URL or a universally unique identifier (UUID). In some embodiments, each of the documents stored in the document database 130 may further be associated with metadata of the document. The metadata may be assigned to the documents by a user and/or automatically by a document processing system.

In some embodiments, the front-end server 107 passes the search queries to the search engine 120. The search engine 120 then communicates with the document database 130 to select one or more items (e.g., documents) in response to a search query. Typically, the search engine 120 ranks the selected items with respect to their relevance to the search query.

The search engine 120 sends a list of search results to the search result processing module 112 in response to the received search query. In some embodiments, each search result includes identification information relating to the documents of the resulted list. Identification information may include for example, document metadata, URL, and/or its generic ranking score. In some embodiments, the search result also comprises the relevant document either wholly or in part. Alternatively, or in addition, in another embodiment, a search result may comprise an URL identifying the source of the document on the Internet, an access path identifying the storage location of the document in a document store, or the like. Each search result may include the document's generic ranking score assigned by the search engine 120 to the document. In some embodiments, the list of search results is ordered by the respective generic ranking score or each item in the list such that each search result has an initial position in the list. For example, the search result having the highest-ranking score is the head of the list and the search result having the lowest ranking score is the tail of the list.

In some embodiments, the search result processing module 112 receives from the profile manager module 108 a unique identifier identifying the requesting user and uses the user identifier to retrieve the search profiles of the identified user from the profile database 110. The profile database 110 stores one or more search profiles, each search profile having one user as an owner. However, a user may have more than one search profile according to the user's needs. For example, a user may have a first search profile relating to travel, a second search profile relating to smartphones, a third search profile relating to a specific field of science or technology, etc.

In some embodiments, a search profile is a specific data structure comprising at least a profile identifier, a profile type, a user identifier, a set of documents the contents of which match a specific topic defined by the user for the search profile, and a set of characteristic features describing the topic of the search in a binary form. In some embodiments, characteristic features are derived from the content of the documents assigned to the search profile. The documents of a search profile may be obtained from searches resulting in relevant documents with respect to the search profile, and/or the documents may be directly selected by the user from a document database or a document store. The documents belonging to the search profile may be collected by the user and assigned to one or more search profiles belonging to the user. The documents belonging to a search profile may at least partly contain information that is relevant to the topic of the search profile from the user's point of view. For the assignment of a search profile to a document, a unique identifier of the search profile is used. The profile identifier may, for example, be a sequence ID or a key of a combination of the user ID and the profile name.

In some embodiments, the search management system 106 may include one or more default search profiles with pre-defined topics to assist the user in the profile building process. A default search profile may then be extended or edited by the user according to the individual needs. A default search profile may even be extended by the system automatically based on appropriate prior user settings. In some embodiments, default profiles may be generated by the system or the administrators, so that the user can start a search with an existing profile. The existing profile used in the search may be extended or edited subsequently. In some embodiments, the system automatically extends a particular profile with relevant documents based on prior user settings.

The search profile may contain a portion of or the entire body of the assigned documents. In some embodiments, the search profile may include only a reference or pointer to the source of the documents. The reference to the source of a document may, for example, be a URL address identifying a website where the document is accessible on the Internet and/or an access path identifying the storage location of the document in a document store.

In some embodiments, a search profile may further include at least one of the following elements: user authorization data, document metadata, short description of the search profile, user relevance scores for the documents, cross-references to other search profiles, etc. The user authorization data may define the operations that can be executed by other users on a shared search profile. Such operations may include viewing the content of the search profile, using the search profile for filtering, adding a new document to the search profile, or removing a document from the search profile by a different user. The use of shared search profiles will be described later in detail.

The short description of a search profile may contain a short text information on the topic of the search profile. This short description may be presented on the screen. The use of a short description for a search profile is beneficial for the owner of the search profile, but also for other users when the search profile is shared. The user relevance score defines a quality factor assigned to a document for indicating the relevance of the document with respect to the associated search profile. The user relevance score may be taken into account in the determination of the characteristic features of the search profile as it will be described later.

Once a list of search results is generated for a search query, the search result processing module 126 may automatically check the user settings relating to the search and, based on the user settings, processing module 126 may determine whether the list of search results should be reordered or filtered using the user's search profile. In some embodiments, the user may be associated with a number of search profiles and may select one of the search profiles to apply to a search prior to executing a search query. When the list of search results requires reordering, the search result processing module 112 may decide, for each document, whether the document matches the current search profile. For each document that matches the current search profile, the search result processing module 112 moves the respective search result to the head portion of the list of search results. In some embodiments, if a document does not match the current search profile, there is no change to its position in the list. The reordered list of search results, or a portion of the list, may be returned to the client 103 as a list of search results customized according to the user's search profile.

Various matching algorithms may be implemented in the search result processing module 112. One algorithm may generate a binary result indicating the extent of similarity, another algorithm may determine a relevance score for the documents. Yet another algorithm may generate a percentage similarity. In the latter two cases, a threshold may be predefined for the score or percentage values, and matching may be defined for those documents the score or percentage value of which exceeds the predefined threshold value.

When the list of search results is subject to filtering based on the prior user settings, the search result processing module 112 decides whether or not a document of the search result matches the current search profile. If the document matches the current search profile, the search result processing module 112 keeps the respective document in the list, otherwise the document is removed from the list. The filtered list of search results, or a portion of the list, is then returned to the client 103 as a personalized list of search results.

The search result processing module 112 may perform a matching function between a search result and a search profile using the characteristic features of the search result and the characteristic features of the search profile. In some embodiments, the classifier may learn the characteristic features of the search profile and may classify the documents listed in the search result based on their respective characteristic features. As a result, the classifier associates a value with each of the documents, said value indicating to what extent the document belongs to the trained class, i.e. the search profile.

The search result processing module 112 may comprise a trainable classifier for determining to what extent a document of the search results belongs to a particular search profile. The trainable classifier is initially trained with the characteristic features of the search profile, and during the matching process the classifier assigns a relevance value for each classified document of the search result. The relevance value is indicative of the extent of a document's matching the particular search profile. The trainable classifier may, for example, comprise a Naive Bayes classifier (particularly suitable for classifying data of any type and text patterns), a Support vector machine (particularly suitable for classifying data of any type, text and audio patterns), a Logistic regression classifier (particularly suitable for classifying data of any type), a Decision tree, an artificial neural network (particularly suitable for classifying data of any type, and audio and video patterns).

In some embodiments, the trainable classifier of the search result processing module 112 may be initialized using an initial set of documents. For example, the user may obtain a set of documents from any source of documents and select which documents from the set are relevant with respect to one or more search profiles for training the classifier. The selected documents may then be used to initially train the classifier with each associated search profile.

Assuming that at least one search result changes its position or gets removed from the list of the search results, the search result processing module 112 returns the modified (i.e., reordered or filtered) list of search results to the front end sever 107. The front-end server 107 may provide the modified list of the search results to the user at the client 103, via client application 132, as a personalized list of search results.

The personalized list of the search results may be provided to the user wholly or partly. For example, only a head portion of the list (i.e., the portion of the list containing the most relevant results) may be provided to the user. In some embodiments, a portion of the personalized list of search results (e.g., the top 20 or 50 search results) is returned to the client 103 and displayed to the requesting user through the client application 132. The requesting user, while browsing the displayed search results, may select one or more documents in the search results and access the documents using the associated URL links or the access paths thereof. When the user finds a document of interest with regard to any one of his search profiles, the user may assign the document to one or more of his search profiles. Upon assigning a new document to a search profile by selecting the respective profile ID, the profile manager module 108 may update the set of characteristic features of the selected search profile based on the extended set of documents.

In some embodiments, the search engine 120 is part of the search management system 106. In such an embodiment, the search result processing module 112 may be integrated into the search engine 120.

In some embodiments, the search management system 106 may include a notification center 114 configured to send notifications to the user of the client 103. A notification may relate to the appearance, in the document database 130, of a new document the content of which matches one of the search profiles of the user. One notification may specify one or more new documents that are automatically determined to be relevant to the user based on any one or more search profiles thereof. In some embodiments, a notification may relate to the use of any one of the search profiles of the user by another user.

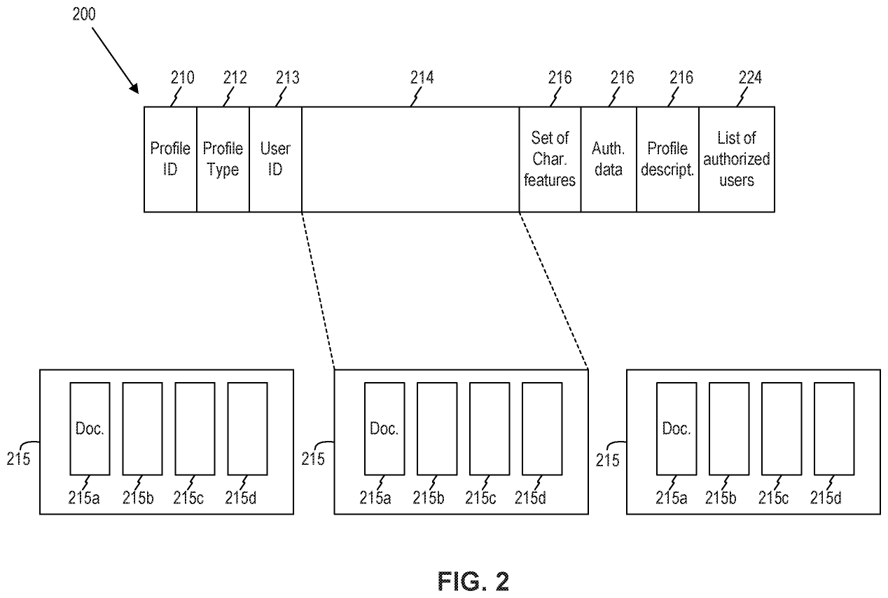

FIG. 2 depicts an exemplary data structure of a search profile 200 consistent with disclosed embodiments. The search profile 200 contains at least a profile ID 210, a profile type 212, a user ID 213, a set of documents 214 assigned to the search profile 200, and a set of characteristic features 216 describing the topic of the search profile 200. The search profile 200 may further contain user authorization data 220, a profile description 222 including a short (or long) textual description of the topic of the search profile 200, and a list 224 of other authorized users who are permitted to utilize the search profile when it is shared. In another embodiment, the profile may include one or more parental controls to filter inappropriate content.

As used herein, the term “characteristic feature” means a set of artificial binary codes representing the content of a document, said codes being provided by applying an appropriate transformation operation to the binary representation of the document. The transformation from the binary representation of a document into the characteristic features (e.g., the artificial binary code for matching purposes) may be executed according to various modeling techniques that are well known to those skilled in the art. Exemplary modeling techniques for text contents include the “bag of words” model, the n-gram model, the skip-gram model and the Neural language model. Exemplary modeling techniques for image contents include the non-local sparse model, the Gaussian mixture model, etc. Exemplary modeling techniques for audio contents include the nearest neighbor method, the nearest feature line method, etc. The foregoing modeling techniques for the generation of characteristic features are well known to those skilled in the art and therefore no further details are given herein about them.

The list 224 of the authorized users may contain the user IDs of those users who can access the search profile when shared. In some embodiments, a search profile may be “private” and “shared” based on user preferences. For example, if a search profile is private, the user may prohibit other users from accessing and using the content of the search profile, and thus also prohibit other users from accessing the sets of documents collected by the user for his various search profiles. If a search profile is set to “shared,” the user allows other users to access and use the search profile. Other privacy settings may be allowed in other embodiments. For example, the user can allow other users to see the full content of the shared search profile, including the various fields of the search profile and the document records. In another example, the user can allow other users to use the search profile, but not to access the specific content of the search profile.

The set of documents 214 may include one or more document records 215. Each document record 215 may include a document 215a (either a part of or the entirety of the document's body, or a physical or logical reference to the document, e.g., an URL link or an access path). The set of documents 214 may be a dynamic data structure since any number of new relevant documents can be added to the set at any time and any number of documents may be removed from the set by the user. When adding a new document to the search profile 200, a new document record 215 is added to the current set of documents 214. In some embodiments, the search profile 200 also allows removal of a document from the set of documents 214. When removing a document from the search profile 200, its document record 215 is deleted from the current set of documents 214.

In some embodiments, a document record 215 may further comprise metadata 215b associated with the respective document, a user relevance score 215c describing the relevance of the document with respect to the topic of the search profile 200, and cross-references 215d specifying one or more other search profiles to which the document is also assigned. A cross-reference may be automatically determined and recorded with the document by the search management system 106 when it detects that one document has been assigned by the user to more than one search profiles, or the user may directly set this parameter using the profile management module 108.

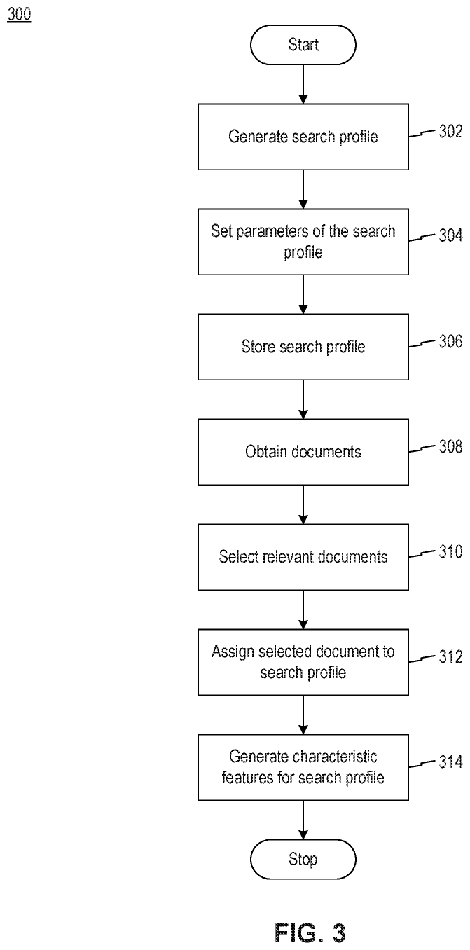

FIG. 3 is a flowchart illustrative of a process 300 for generating a search profile according to disclosed embodiments. Initially, in step 302, an instance of a data structure for at least one search profile is generated by the user using a graphical user interface (GUI) managed by the front-end server 107 and displayed by the client 103 to the user. As mentioned above, the search profile may be formed of a dynamic data structure that allows addition of further documents to the search profile, and/or allows the removal of documents from the search profile when the user qualifies the document as being irrelevant with respect to the topic of the search profile.

In step 304, the parameters of the data structure of the search profile are set by the user through the GUI by means of the profile management module 108 and thus an initial data structure for a search profile is generated.

In step 306, the initial data structure of the search profile is automatically stored by the profile management module 108 in permanent data storage, for example, the profile database 110 of search management system 106.

In step 308, to find and assign relevant documents to a search profile, the user may obtain one or more documents by executing a search query or by directly selecting documents from a document store. At step 310, the user may select one or more documents relevant to the topic of the search profile. At step 312, the user assigns the selected documents to the search profile. As mentioned above, one document may be assigned to more than one search profile of the user. The documents assigned to the search profile may be automatically added to the set of documents associated with the search profile by the profile management module 108.

At step 314, when one or more documents are assigned to a particular search profile, the system may automatically determine a set of characteristic features for the search profile. In some embodiments, the set of characteristic features is automatically generated by the profile management module 108 based on the one or more documents assigned to the search profile. In some embodiments, a search profile may have a default set of characteristic features which will be trained when the user conducts subsequent searches for documents relating to the topic of the untrained search profile.

In some embodiments, in addition to the content of the documents assigned to the search profile, at least one of the metadata of the documents and the user relevance scores of the documents may also be used to generate the set of characteristic features of the search profile. For example, the user may assign a relevance score to each of the documents assigned to a search profile. The relevance score may indicate, for example, the degree of correlation between the document and the topic of the associated search profile. In this case a document with a higher user relevance score may be stronger weighted in the generation of the characteristic features of the search profile in order to define the topic of the search profile more accurately.

In some embodiments, the user may associate metadata with the documents of a search profile through the GUI. The selected metadata may be stored in the search profile by the profile management module 108. In some embodiments, the profile management module 108 may generate authorization data for the search profile to restrict the access to and the use of a search profile by other users. In some embodiments, the profile management module 108 may record one or more cross-references for a document to specify one or more other search profiles to which the document is also assigned.

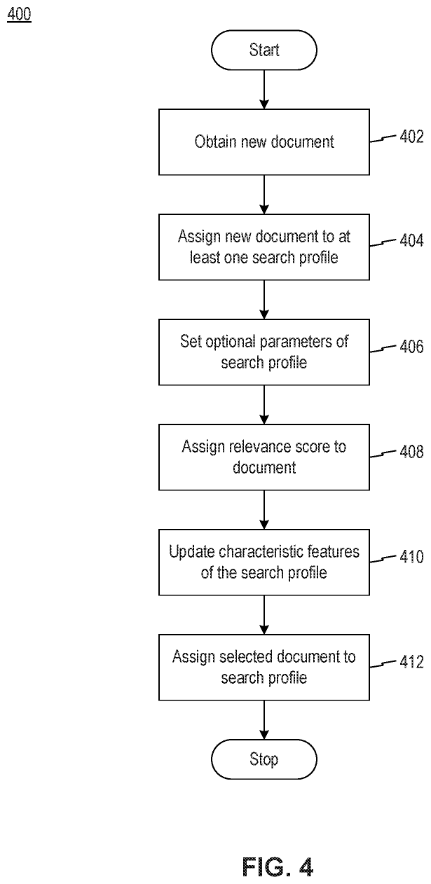

FIG. 4 is a flowchart illustrative of a process 400 for updating a search profile in accordance with disclosed embodiments.

In step 402, a new document relevant to at least one search profile is obtained by the user via execution of a search query or by direct selection of a document from a document store.

In step 404, the user assigns the new document to at least one search profile. In some embodiments, the new document may be assigned to multiple search profiles. For example, the content and/or metadata of the document may be relevant to the topics of a number of search profiles of the user. Once the user has assigned the new document to a search profile, the profile management module 108 automatically adds the new document to the set of documents associated with the search profile.

Upon the assignment of the new document to the search profile, the respective parameters of the data structure of the search profile relating to the documents (e.g., metadata of the document, cross-references to other search profiles) may be set by the user, in step 406, through the GUI by means of the profile management module 108. In some embodiments, the relevance of the new document with respect to the associated search profile may be evaluated by the user in step 408, who may assign a relevance indicator or score to the document.

In step 410, an updated set of characteristic features for the search profile is generated using the content of the recently added document. The updated set of characteristic features improves the accuracy of the search results.

At step 412, the user assigns the selected documents to the search profile, for example, via a GUI displayed on client 103.

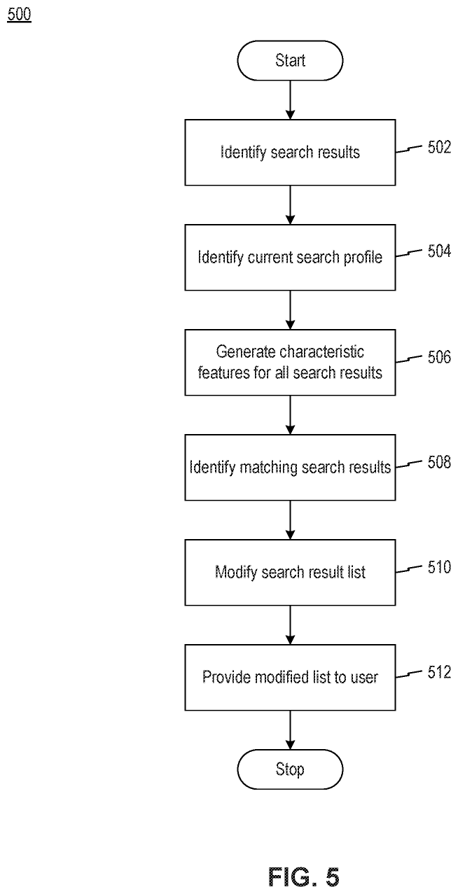

FIG. 5 is a flowchart illustrative of a process 500 for personalizing search results using a search profile of a user in accordance with disclosed embodiments. The process shown in FIG. 5 may be completed after a user has previously executed a search query to find relevant documents relating to a specific topic of an existing search profile. For example, the user may have executed a previous search query using a search engine 120 to find relevant documents in a document database 130. The search engine 120 may be any kind of search engine configured to find relevant documents using a programmed search scheme. Examples of appropriate search engines include the internet search engine of Google, Microsoft Bing, Elasticsearch, Apache Solr, etc., and other dedicated search engines developed for specific (either public or private) document databases or document stores (e.g., MySQL, Oracle, MSSQL).

In step 502, the search result processing module 112 identifies a list of search results associated with a search query from the user. As noted above, the list of search results is produced by the search engine 120 while processing the search query. Each search result in the list has an initial position that is dependent at least in part on the search result's generic ranking score internally computed by the search engine 120.

In step 504, the search result processing module 112 identifies the search profile that the user has selected for the current search from among the user's one or more search profiles.

In step 506, the search result processing module 112 generates a set of characteristic features for each search result based on the content of each result by using a built-in modeling technique. The modeling technique used for the search results corresponds to the modeling technique used for the search profile. The modeling technique may be different for textual contents, image contents, audio content, video contents and multimedia contents. As previously described, a non-limiting list of exemplary modeling techniques for text content may include the “bag of words” model, the n-gram model, the skip-gram model and the Neural language model.

In step 508, the search result processing module 112 identifies one or more search results in the returned list, the contents of which match the search profile based on a comparison of the characteristic features of the search result and the search profile. The matching process uses the characteristic features of the search results and the characteristic features of the current search profile. Based on the degree of matching between a search result and the current search profile, a quality factor may be calculated by the search result processing module 112 for each search result according to a predetermined scheme, wherein the quality factor indicates the relevance of the search result with respect to the current search profile.

In step 510, using the quality factors of the search results generated during the matching process, the search result processing module 112 may modify the number and/or the order of the search results in the list of search results returned by the search engine 120, thereby generating a customized list of search results based on the relevance of the search results with respect to the search profile.

In some embodiments, in step 510, the search result processing module 112 may reorder the list of the search results based on the quality factors of the search results. In some embodiments, the search result processing module 112 may filter the list of the search results based on the quality factor of the search results determined in the matching process, and according to predefined filtering criteria, and may provide a filtered list of search results. For example, the filtered list of search results may include only those search results that fulfill the predefined filtering criteria.

In some embodiments, in step 510, the search result processing module 112 may filter the list of the search results based on the quality factor of the search results and provide a filtered list of search results including only those search results that fulfill the predefined filtering criteria. In a subsequent step, the search result processing module 112 may delete, from the filtered list, those search results that have already been included in the document list of the current search profile. Thus, the system may provide the user with a further reduced list of search results including only those documents that are relevant to the current search profile and that are regarded as new search results, i.e., that do not appear in the set of documents associated with the current search profile.

Filtering criteria may, for example, define a threshold value for the quality factor of the search results such that a search result is included in the filtered list if its quality factor exceeds the threshold value. When the quality factor of a search result is defined as a relevance score of the search result with respect to a current search profile, for example, the filtering criteria may include a threshold value for the relevance of the search results. For example, the quality factor may be obtained by normalizing the relevance score to the range (0,1), wherein 1 means perfect (100%) relevance, and 0 means no (0%) relevance. In some embodiments, a search result is included in the filtered list if its relevance score exceeds the threshold value.

In step 512, the search result processing module 112 provides the modified list of search results to the user on client 103 via the front-end server 107.

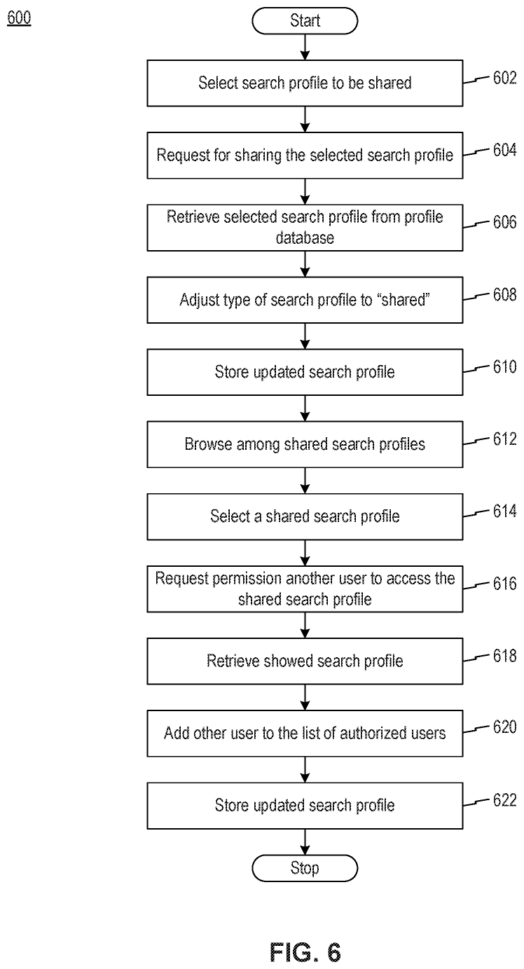

In some embodiments, the search profile of a user may be shared with other users. This sharing process 600 is described with reference to FIG. 6. To share a search profile, in step 602, a first user may select the search profile for sharing by means of the GUI displayed on the client 103. In step 604, once the search profile to be shared has been selected by the first user, the front-end server 107 sends a sharing request to the profile management module 108. In step 606, the profile management module 108 retrieves the selected search profile from the profile database 110. In step 608, the profile management module 108 adjusts the type of the search profile to “shared,” and, in step 610, stores the updated search profile in the profile database 110.

In step 612, a second user who wishes to use a shared profile of the first user may browse among the shared search profiles by means of the GUI presented on his client 103, and, in step 614, may select a shared search profile of the first user. The selection from the available shared search profiles may be assisted by presenting a short description of the shared search profiles. In some embodiments, a name or other identifier of the user who created the profile may be displayed for each shared search profile.

In step 616, once the second user has selected a shared search profile of the first user, the front-end server 107 sends an authorization request to the profile management module 108. The authorization request may contain, for example, the user ID of the user who wishes to access to the shared search profile. The profile management module 108 then retrieves the selected search profile from the profile database 110 in step 618, and if the authorization request is granted, in step 620, the profile management module 108 will add the second user's user ID to the search profile's list of authorized users. In step 622, the profile management module 108 stores the updated search profile, including the updated list of authorized users, in the profile database 110. Once authorized, the second user may use the search profile of the first user in search processes. In some embodiments, when another user selects and obtains authorization to use a search profile, the owner of the search profile may receive a notification from the profile management module 108 through the notification center 114. For example, notification center 114 may send a notification through the front-end server 107 to the owner of the search profile. This notification may be displayed on the GUI presented by the client 103.

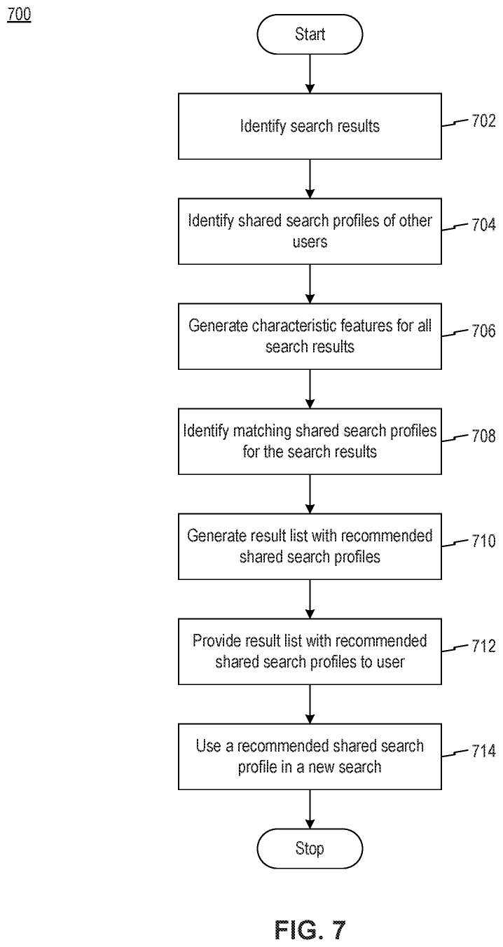

In another embodiment, a method of personalizing search results using multiple search profiles is provided. FIG. 7 is a flowchart illustrative of a process 700 for personalizing search results using multiple shared search profiles of other users in accordance with some embodiments.

Initially, in step 702, the search result processing module 112 identifies a list of search results associated with the search query from the user. As noted above, the list of search results is produced by the search engine 120 while processing the search query. Each search result in the list has an initial position that is dependent at least in part by the search result's generic ranking score internally computed by the search engine 120.

Next, in step 704, the search result processing module 112 automatically identifies one or more shared search profiles of other users that are accessible by the user performing the search.

In step 706, the search result processing module 112 generates a set of characteristic features for each search result based on their content.

The search result processing module 112 then identifies, in step 708, one or more shared search profiles of other users, the topics of which match the content of the search results based on the characteristic features of the search results and the characteristic features of said plurality of shared search profiles. Based on the degree of matching between a search result and a shared search profile, a set of quality factors is calculated by the search result processing module 112 for each shared search profile with respect to the different search results according to a predetermined scheme, wherein a quality factor is indicative of the degree of matching between the topic of a shared search profile and the content of a search result.

Next, in step 710, using the sets of quality factors of the shared search profiles obtained in the matching process, the search result processing module 112 may generate a list of at least one shared search profile for recommendation for the user with regard to the current search results. In some embodiments, the recommended shared search profiles may be associated with one or more search results of the current list of search result. Alternatively, or in addition, the recommended shared search profiles belonging to a specific search may be presented to the user in a separate list. In some embodiments, a number of different shared search profiles of one or more other users may be associated with a particular search result.

In some embodiments, a shared search profile of another user may be selected for recommendation to a search result if the respective quality factor meets predefined filtering criteria. For example, a quality factor of a shared search profile may be defined as a score of relevance of the shared search profile with respect to a search result and the filtering criteria may include a threshold value for the relevance of the shared search profile. In this case, a shared search profile may be selected for a search result if its score of relevance exceeds said threshold value.

In step 712, the search result processing module 112 may provide the list of search results with recommended shared profiles to the user through the front-end server 107.

Finally, in step 714, the user may select and use a recommended shared search profile of another user instead of his/her own search profiles in a search to obtain a personalized list of search results.

In some embodiments, one or more shared search profiles of one or more other users can be recommended to the user in relation with one or more search results provided by a search engine upon a search query from the user. The user may then decide whether to use any one of the recommended shared search results at a future search in a specific topic to obtain even better personalized search results. The more personalized and thus more accurate search results lead to a reduced number of search runs by the users, which, in turn, results in a reduced bandwidth use over the communication network.

In some embodiments, the search result processing module 112 may delete, from the returned list, the search results with which no search profile of the user could be associated, thereby the system may provide the user with a reduced list of search results that include only those search results for which at least one of the user's search profile has been recommended as a result of the matching process.

In some embodiments, the search result processing module 112 may delete, from the returned list, the search results which have already been included in the list of documents assigned to a search profile of the user, thereby the system may provide the user with a reduced list of search results that include only those documents which are regarded as new search results.

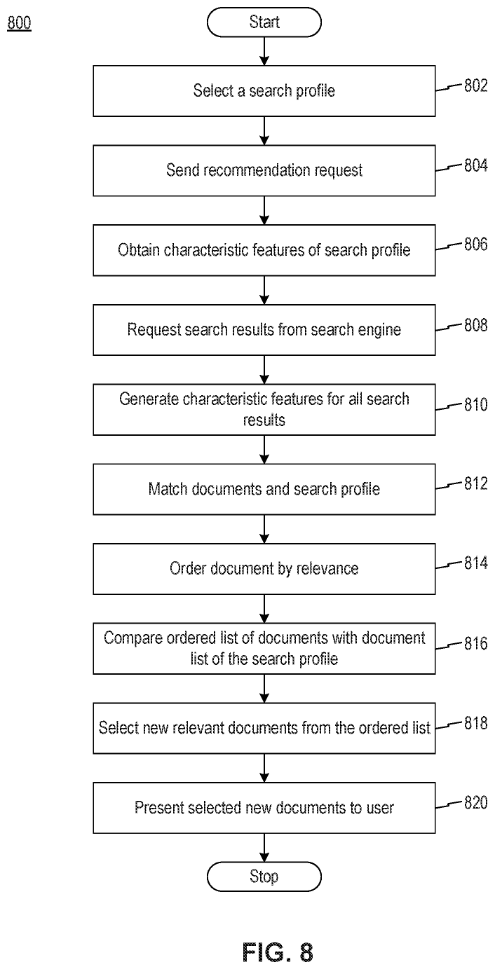

FIG. 8 is a flowchart illustrative of a process 800 for recommending search results in accordance with some embodiments. In some embodiments, one or more documents of document database 130 may be automatically recommended by the system to train a classifier of a search profile. In step 802, the user may select a search profile through the GUI presented by the client 103 and, in step 804, upon selection of the search profile the front-end server 107 sends a recommendation request to the search profile management module 108. In step 806, the search profile management module 108 retrieves the selected search profile from the profile database 110 and obtains the set of characteristic features of the selected search profile. The search profile management module 108 may send the set of characteristic features to the search result processing module 112. Concurrently, or in tandem, in step 808, front-end server 107 may send a request to the document database 130 to provide the search result processing module 112 with the set of currently available documents.

In step 810, the search result processing module 112 may generate a set of characteristic features for the documents received from the documents database 130, and, in step 812, the search result processing module 112 may match the documents and the selected search profile based on the characteristic features of the respective documents and those of the selected search profile. In step 814, the search result processing module 112 may reorder the documents based on relevance with respect to the topic of the selected search profile. In step 816, the search result processing module 112 may compare the reordered list of documents with the existing list of documents of the selected search profile. In step 818, the search result processing module 112 may select, from the ordered list, one or more relevant documents that are not included in the document list of the selected search profile. The new relevant documents may be selected using various selection schemes. For example, a predefined number of new documents may be selected or alternatively, only the documents, the relevance of which meets certain filtering criteria, may be selected.

In step 820, the selected new documents may be presented through the GUI of client 103 to the user as a list of recommended documents, and the user may one or more documents to add to the selected search profile. The selection of the one or more documents may trigger an automatic training of the classifier of the selected search profile using the currently added one or more documents.

In some embodiments, a personalized list of search results can be provided to a user, wherein the list includes one or more documents that have a high relevance to the user with respect to a specific topic defined by the user through a search profile. The topic of a search profile can be made increasingly more accurate through direct user interactions with the search profile. The more accurate search results lead to a reduced number of search runs by the users, which, in turn, results in a reduced bandwidth use over the communication network.

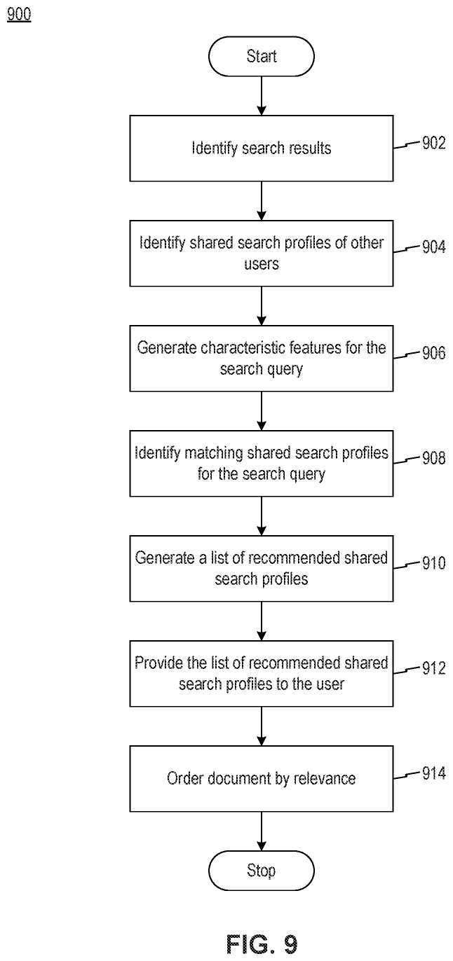

In another embodiment, search results may be personalized by using multiple search profiles. FIG. 9 is a flowchart illustrative of a process 900 for personalizing search results using multiple shared search profiles of other users in accordance with disclosed embodiments.

In step 902, the search result processing module 112 receives a search query from the user. The search query may comprise textual content, image content, audio content or any combination thereof. As noted above, the list of search results according to the search query is produced by the search engine 120 while processing the search query.

In step 904, the search result processing module 112 automatically identifies one or more shared search profiles of other users that are accessible by the user performing the search. For example, shared search profiles may be made accessible to a user via process 600 described above.

In step 906, the search result processing module 112 generates a set of characteristic features for the search query based on its content.

The search result processing module 112 may then identify, in step 908, one or more shared search profiles of other users, the topics of which match the content of the received search query based on the characteristic features of the search query and the characteristic features of said plurality of shared search profiles. Based on the degree of matching between the search query and a shared search profile, a quality factor is calculated by the search result processing module 112 for the shared search profile according to a predetermined scheme. The quality factor may be indicative of the degree of matching between the topic of the shared search profile and the content of the search query.

In step 910, based on the quality factors of the shared search profiles obtained in the matching process, the search result processing module 112 may generate a list of at least one shared search profile for recommendation to the user with regard to the current search query.

In step 912, the search result processing module 112 may provide the list of recommended shared search profiles, via a display of client 103, to the user through the front-end server 107.

In step 914, the user may select and use any one or more of the recommended shared search profiles of other user(s) instead of his/her own search profiles in a search to obtain a personalized list of search results.

In some embodiments, the step of identifying the one or more shared search profiles for the search query may include determining a set of quality factors for the search query according to a predetermined scheme, wherein the quality factor is indicative of the degree of matching between the topic of the shared search profile and the content of a search query.

In some embodiments, when generating the list of at least one recommended shared search profile, a shared search profile may be recommended only if the quality factor of the shared search profile meets predefined filtering criteria. Otherwise the search profile may be disregarded.

In some embodiments, the quality factor is defined as a score of relevance of the shared search profile with respect to the search query. In this case, the filtering criteria may include a threshold value for the relevance of the shared search profile. A shared search profile may then be recommended to the search query if its score of relevance exceeds said threshold value, otherwise the search profile may be disregarded.

In some embodiments, one or more shared search profiles of one or more other users may be recommended to the user in relation to a specific search query from the user. The user may then decide whether to use any one of the recommended shared search profiles at a future search in a specific topic to obtain even better personalized search results. The more personalized and thus more accurate search results lead to a reduced number of search runs by the users, which, in turn, results in a reduced bandwidth use over the communication network.

The processes of generating, updating and sharing a search profile may be executed as described with reference to FIGS. 3, 4 and 6, respectively.

The systems and methods described herein provide search techniques to improve user experience and search efficiency, as well as reduce bandwidth use over the communication network. In some embodiments, the search techniques improve upon current search engine systems by providing the user control over one or more search profiles. Due to these improvements the search engine system of the present invention allows users to execute more efficient searches by facilitating.

The foregoing description of disclosed embodiments provides illustration and description, but is not intended to be exhaustive or to limit the invention to the precise form disclosed. Modifications and variations are possible in light of the above teachings or may be acquired from practice of the disclosure. In particular, while exemplary methods of the present invention are described as a series of acts, the order of the acts may vary in other implementations consistent with the present invention. Non-dependent acts may be performed in any order or in parallel.

The scope of the invention is defined by the claims and their equivalents.

In a first aspect, the computer system for producing personalized search results comprises:
a memory;
one or more processors; and
one or more programs stored in the memory and configured for execution by the one or more processors, the one or more programs including:
instructions for identifying a list of search results associated with a search query from a user;
instructions for identifying a search profile of the user, wherein the search profile includes an identification of a set of documents collected by the user, wherein the documents belonging to the search profile have a content matching a specific topic defined by the user for the search profile, and wherein the search profile further includes an identification of a set of characteristic features describing the search topic in a binary form, said characteristic features of the search profile being derived from at least the content of the documents assigned to the search profile;
instructions for generating a set of characteristic features for each search result of the returned list, said set of characteristic features describing the content of the search result in a binary form;
instructions for identifying in the list of search results, one or more search results the contents of which match the search profile based on the characteristic features of the search results and the characteristic features of the search profile;
instructions for generating, in response to the matching, a second list of search results depending on the relevance of the search results with respect to the search profile; and
instructions for providing the second list of search results to the user.

In the first system the instructions for generating the second list of search results further comprise reordering the first list of the search results based on one or more quality factors determined for each search result in the matching process according to a predetermined scheme.

In the first system the instructions for generating the second list of search results further comprises filtering the second list of search results by one or more quality factors determined for each search result in the matching process.

In the first system filtering the second list search results further comprises selecting one or more search results having a quality factor meeting a predefined filtering criteria.

A non-transitory computer readable storage medium storing one or more programs to be executed by a computer system, the one or more programs comprising:
instructions for identifying a list of search results associated with a search query from a user;
instructions for identifying a search profile of the user, wherein the search profile includes an identification of a set of documents collected by the user, wherein the documents belonging to the search profile have a content matching a specific topic defined by the user for the search profile, and wherein the search profile further includes an identification of a set of characteristic features describing the search topic in a binary form, said characteristic features of the search profile being derived from at least the content of the documents assigned to the search profile;
instructions for generating a set of characteristic features for each search result of the returned list, said set of characteristic features describing the content of the search result in a binary form;
instructions for identifying in the list of search results, one or more search results the contents of which match the search profile based on the characteristic features of the search results and the characteristic features of the search profile; instructions for generating, in response to the matching, a personalized list of search results depending on the relevance of the search results with respect to the search profile; and
instructions for providing the personalized list of search results to the user.

In a second aspect, the computer system for producing personalized search results comprises:
a memory;
one or more processors; and
one or more programs stored in the memory and configured for execution by the one or more processors, the one or more programs including:
instructions for identifying a list of search results associated with a search query from a user;
instructions for identifying a plurality of shared search profiles of one or more other users, wherein a shared search profile includes an identification of a set of documents collected by the user, wherein the documents belonging to a search profile have a content matching a specific topic defined by the user for the respective search profile, and wherein each search profile further includes an identification of a set of characteristic features describing a search topic in a binary form, said characteristic features of the search profile being derived from at least the content of the documents assigned to the respective search profile, instructions for generating a set of characteristic features for each search result of the returned list, said set of characteristic features describing the content of the search result in a binary form,
instructions for identifying, for at least one search result, one or more shared search profiles of the one or more other users, the topics of which match the content of the search results based on the characteristic features of the search results and the characteristic features of said plurality of shared search profiles; instructions for generating a list of search results with recommended shared search profiles based on the matching process, wherein at least one shared search profile of at least one other user is associated with at least one of the search results;
instructions for providing the list of search results with recommended shared search profiles to the user; and
instructions for using the selected recommended shared search profile in a new search to obtain a personalized list of search results upon selecting a recommended shared search profile of another user.

In the second system the instructions for identifying one or more shared search profiles for the search results comprise determining a set of quality factors for each shared search profile according to a predetermined scheme, a quality factor being indicative of the degree of matching between the topic of the shared search profile and the content of a search result.

In the second system generating the list of search results comprises selecting a shared search profile for recommendation to a search result if the respective quality factor meets predefined filtering criteria.

In the second system a quality factor of a search profile is defined as a score of relevance of the shared search profile with respect to a search result, and the filtering criteria includes a threshold value for the relevance of the shared search profile, and a shared search profile is recommended to a search result if its score of relevance exceeds said threshold value.

A non-transitory computer readable storage medium storing one or more programs to be executed by a computer system, the one or more programs comprising:
instructions for identifying a list of search results associated with a search query from a user;
instructions for identifying a plurality of shared search profiles of one or more other users, wherein a shared search profile includes an identification of a set of documents collected by the user, wherein the documents belonging to a search profile have a content matching a specific topic defined by the user for the respective search profile, and wherein each search profile further includes an identification of a set of characteristic features describing a search topic in a binary form, said characteristic features of the search profile being derived from at least the content of the documents assigned to the respective search profile, instructions for generating a set of characteristic features for each search result of the returned list, said set of characteristic features describing the content of the search result in a binary form,
instructions for identifying one or more shared search profiles of the one or more other users for at least one search result, the topics of which match the content of the search results based on the characteristic features of the search results and the characteristic features of said plurality of shared search profiles; instructions for generating a list of search results with recommended shared search profiles based on the matching process, wherein at least one shared search profile of at least one other user is associated with at least one of the search results;
instructions for providing the list of search results with recommended shared search profiles to the user; and
instructions for using the selected recommended shared search profile in a new search to obtain a personalized list of search results upon selecting a recommended shared search profile of another user.

In a third aspect, the computer system for producing personalized search results comprises:
a memory;
one or more processors; and
one or more programs stored in the memory and configured for execution by the one or more processors, the one or more programs including:
instructions for identifying a search query from a user;
instructions for identifying a plurality of shared search profiles of one or more other users, wherein each search profile include an identification of a set of documents collected by the user, wherein the documents belonging to a search profile have a content matching a specific topic defined by the user for the respective search profile, and wherein each search profile further includes an identification of a set of characteristic features describing a search topic in a binary form, said characteristic features of the search profile being derived from at least the content of the documents assigned to the respective search profile, instructions for generating a set of characteristic features for the search query, said set of characteristic features describing the content of the search query in a binary form,
instructions for identifying one or more shared search profiles of the one or more other users for the search query, the topics of which match the content of the search query based on the characteristic features of the search query and the characteristic features of said plurality of shared search profiles;
instructions for generating a list of at least one recommended shared search profile based on the matching process;
instructions for providing the list of the at least one recommended shared search profile to the user; and
instructions for using the selected recommended shared search profile in a new search to obtain a personalized list of search results upon selecting a recommended shared search profile of another user.

In the third system the instructions for identifying one or more shared search profiles for the search query comprise determining a set of quality factors for the search query according to a predetermined scheme, a quality factor being indicative of the degree of matching between the topic of the shared search profile and the content of a search query.

In the third system the instructions for generating the list of at least one recommended shared search profile comprise selecting a shared search profile for recommendation to the search query if the respective quality factor meets predefined filtering criteria.

In the third system a quality factor of a search profile is defined as a score of relevance of the shared search profile with respect to the search query, and the filtering criteria includes a threshold value for the relevance of the shared search profile, and a shared search profile is recommended to the search query if its score of relevance exceeds said threshold value.

A non-transitory computer readable storage medium storing one or more programs to be executed by a computer system, the one or more programs comprising:
instructions for identifying a search query from a user;
instructions for identifying a plurality of shared search profiles of one or more other users, wherein each search profile include an identification of a set of documents collected by the user, wherein the documents belonging to a search profile have a content matching a specific topic defined by the user for the respective search profile, and wherein each search profile further includes an identification of a set of characteristic features describing a search topic in a binary form, said characteristic features of the search profile being derived from at least the content of the documents assigned to the respective search profile, instructions for generating a set of characteristic features for the search query, said set of characteristic features describing the content of the search query in a binary form,
instructions for identifying one or more shared search profiles of the one or more other users for the search query, the topics of which match the content of the search query based on the characteristic features of the search query and the characteristic features of said plurality of shared search profiles;
instructions for generating a list of at least one recommended shared search profile based on the matching process;
instructions for providing the list of the at least one recommended shared search profile to the user; and
instructions for using the selected recommended shared search profile in a new search to obtain a personalized list of search results upon selecting a recommended shared search profile of another user.

What is claimed is:

1. A computer-implemented method of producing personalized search results comprising: identifying a first list of search results associated with a search query from a user;
identifying a search profile of the user, wherein the search profile includes:
an identification of a topic defined by the user;
an identification of a set of documents associated with the user, wherein the set of documents contains content matching the topic defined by the user; and
an identification of a set of characteristic features describing the topic in a binary form, wherein the set of characteristic features is derived from at least the content of the set of documents;
generating a set of characteristic features for each search result of the first list of search results, wherein each set of characteristic features describes the content of a search result in a binary form;
identifying, in the first list of search results, one or more search results having characteristic features matching the characteristic features of the search profile;
based on the matching, generating a second list of search results organized by the relevance of the search results with respect to the search profile; and
providing the second list of search results to the user.

2. The method of claim 1, wherein generating the second list of search results further comprises reordering the first list of the search results based on one or more quality factors determined for each search result in the matching process according to a predetermined scheme.

3. The method of claim 1, wherein the step of generating the second list of search results further comprises filtering the second list of search results by one or more quality factors determined for each search result in the matching process.

4. The method of claim 3, wherein filtering the second list search results further comprises selecting one or more search results having a quality factor meeting a predefined filtering criteria.

5. The method of claim 4, wherein the quality factor of a search result comprises a relevance score of the search result with respect to the search profile.

6. The method of claim 4, wherein the filtering criteria comprises a threshold value for the relevance score.

7. A computer-implemented method of producing personalized search results, performed on a server system having one or more processors and memory storing one or more programs for execution by the one or more processors to perform the method, comprising:
identifying a list of search results associated with a search query from a user;
identifying a plurality of shared search profiles of one or more other users, wherein a shared search profile includes an identification of a set of documents collected by the user, wherein the documents belonging to a search profile have a content matching a specific topic defined by the user for the respective search profile, and wherein each search profile further includes an identification of a set of characteristic features describing a search topic in a binary form, said characteristic features of the search profile being derived from at least the content of the documents assigned to the respective search profile,
generating a set of characteristic features for each search result of the returned list, said set of characteristic features describing the content of the search result in a binary form,
for at least one search result, identifying one or more shared search profiles of the one or more other users, the topics of which match the content of the search results based on the characteristic features of the search results and the characteristic features of said plurality of shared search profiles;
based on the matching process, generating a list of search results with recommended shared search profiles, wherein at least one shared search profile of at least one other user is associated with at least one of the search results;
providing the list of search results with recommended shared search profiles to the user; and
upon selecting a recommended shared search profile of another user, using the selected recommended shared search profile in a new search to obtain a personalized list of search results.

8. The method of claim 7, wherein the step of identifying one or more shared search profiles for the search results comprises determining a set of quality factors for each shared search profile according to a predetermined scheme, a quality factor being indicative of the degree of matching between the topic of the shared search profile and the content of a search result.

9. The method of claim 8, wherein the step of generating the list of search results comprises selecting a shared search profile for recommendation to a search result if the respective quality factor meets predefined filtering criteria.

10. The method of claim 9, wherein a quality factor of a search profile is defined as a score of relevance of the shared search profile with respect to a search result, and the filtering criteria includes a threshold value for the relevance of the shared search profile, and a shared search profile is recommended to a search result if its score of relevance exceeds said threshold value.

11. A computer-implemented method of producing personalized search results, performed on a server system having one or more processors and memory storing one or more programs for execution by the one or more processors to perform the method, comprising:
identifying a search query from a user;
identifying a plurality of shared search profiles of one or more other users, wherein each search profile include an identification of a set of documents collected by the user, wherein the documents belonging to a search profile have a content matching a specific topic defined by the user for the respective search profile, and wherein each search profile further includes an identification of a set of characteristic features describing a search topic in a binary form, said characteristic features of the search profile being derived from at least the content of the documents assigned to the respective search profile,
generating a set of characteristic features for the search query, said set of characteristic features describing the content of the search query in a binary form,
for the search query, identifying one or more shared search profiles of the one or more other users, the topics of which match the content of the search query based on the characteristic features of the search query and the characteristic features of said plurality of shared search profiles;
based on the matching process, generating a list of at least one recommended shared search profile;
providing the list of the at least one recommended shared search profile to the user; and
upon selecting a recommended shared search profile of another user, using the selected recommended shared search profile in a new search to obtain a personalized list of search results.

12. The method of claim 11, wherein the step of identifying one or more shared search profiles for the search query comprises determining a set of quality factors for the search query according to a predetermined scheme, a quality factor being indicative of the degree of matching between the topic of the shared search profile and the content of a search query.

13. The method of claim 12, wherein the step of generating the list of at least one recommended shared search profile comprises selecting a shared search profile for recommendation to the search query if the respective quality factor meets predefined filtering criteria.

14. The method of claim 13, wherein a quality factor of a search profile is defined as a score of relevance of the shared search profile with respect to the search query, and the filtering criteria includes a threshold value for the relevance of the shared search profile, and a shared search profile is recommended to the search query if its score of relevance exceeds said threshold value.
